(19) United States
(12) Patent Application Publication
(10) Pub. No.: US 2015/0350046 A1
(43) Pub. Date: Dec. 3, 2015

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Roshan THAPLIYA, Yokohama-shi (JP); Haiyang MA, Yokohama-shi (JP)

(73) Assignee: FUJI XEROX CO., LTD., Tokyo (JP)

(21) Appl. No.: 14/530,026

(22) Filed: Oct. 31, 2014

(30) Foreign Application Priority Data
May 30, 2014 (JP) 2014-112553

(51) Int. Cl. H04L 12/26; H04L 29/08

(52) U.S. Cl. CPC H04L 43/0852; H04L 67/10

(57) ABSTRACT

An information processing apparatus includes: a reception unit that sequentially receives a plurality of UDP packets sequentially transmitted in a certain data size and at a certain time interval; a first and second calculation units that acquire a plurality of reception time intervals each between two UDP packets successively received by the reception unit, and calculate evaluation values for evaluating a delay state of the reception time intervals; a determination unit that combines the evaluation value calculated by the first calculation unit and the evaluation value calculated by the second calculation unit, and determines reliability of the evaluation values based on at least the two evaluation values; and a bandwidth information outputting unit that outputs bandwidth information according to a bit rate determined by the certain data size and the certain time interval on the basis of the reliability of the evaluation values determined by the determination unit.

### CROSS-REFERENCE TO RELATED APPLICATIONS

This application is based on and claims priority under 35 USC 119 from Japanese Patent Application No. 2014-112553, filed on May 30, 2014.

### BACKGROUND

1. Technical Field

The present invention relates to an information processing apparatus and a non-transitory computer readable medium.

2. Related Art

Bandwidths are measured by UDP packet communication between plural information processing apparatuses. However, the measurement of the bandwidths by the UDP packet communication requires a long time, and is easily influenced by abnormal values.

### SUMMARY

An aspect of the invention provides an information processing apparatus including: a reception unit that sequentially receives a plurality of UDP packets sequentially transmitted in a certain data size and at a certain time interval; a first calculation unit that acquires a plurality of reception time intervals each between two UDP packets successively received by the reception unit, and calculates an evaluation value for evaluating a delay state of the reception time intervals with respect to the certain time interval on the basis of the plurality of the acquired reception time intervals and the certain time interval; a second calculation unit that calculates an evaluation value for evaluating a delay state of the reception time intervals with respect to the certain time interval on the basis of reception time intervals acquired based on a condition for deleting an abnormal value among the plurality of the reception time interval each between two UDP packets successively received by the reception unit and the certain time interval; a determination unit that combines the evaluation value calculated by the first calculation unit and the evaluation value calculated by the second calculation unit, and determines reliability of the evaluation values based on at least the two evaluation values; and a bandwidth information outputting unit that outputs bandwidth information according to a bit rate determined by the certain data size and the certain time interval on the basis of the reliability of the evaluation values determined by the determination unit.

### BRIEF DESCRIPTION OF THE DRAWINGS

Exemplary embodiment(s) of the present invention will be described in detail based on the following figures, wherein

FIG. 1 is a diagram illustrating an example of an entire configuration of an information processing system according to an embodiment;

FIG. 2 is a diagram illustrating an example of a hardware configuration of a server according to the embodiment;

FIG. 3 is a functional block diagram illustrating an example of main functions realized by a control unit of the server according to the embodiment;

FIG. 4 is a flow chart illustrating an example of a process of calculating a first evaluation value (a first evaluation value calculating process);

FIG. 5 is a diagram schematically illustrating an aspect of transmission and reception of a UDP packet according to the embodiment;

FIG. 6 is a flow chart illustrating an example of a process of calculating a second evaluation value (a second evaluation value calculating process);

FIG. 7 is a flow chart illustrating an example of a process of calculating a third evaluation value (a third evaluation value calculating process);

FIG. 8 is a flow chart illustrating an example of a first bandwidth setting process performed by the server;

FIG. 9 is a diagram illustrating an example of a relationship between a bit rate Rn and a total evaluation value Sum^{Rn};

FIG. 10 is a flow chart illustrating an example of a second bandwidth setting process performed by the server; and

FIG. 11 is a diagram illustrating an example of total evaluation values at respective bit rates in a second bandwidth setting process.

### DETAILED DESCRIPTION

Hereinafter, an embodiment of the invention is described in detail with reference to the drawings.

[1. Description of System Configuration]

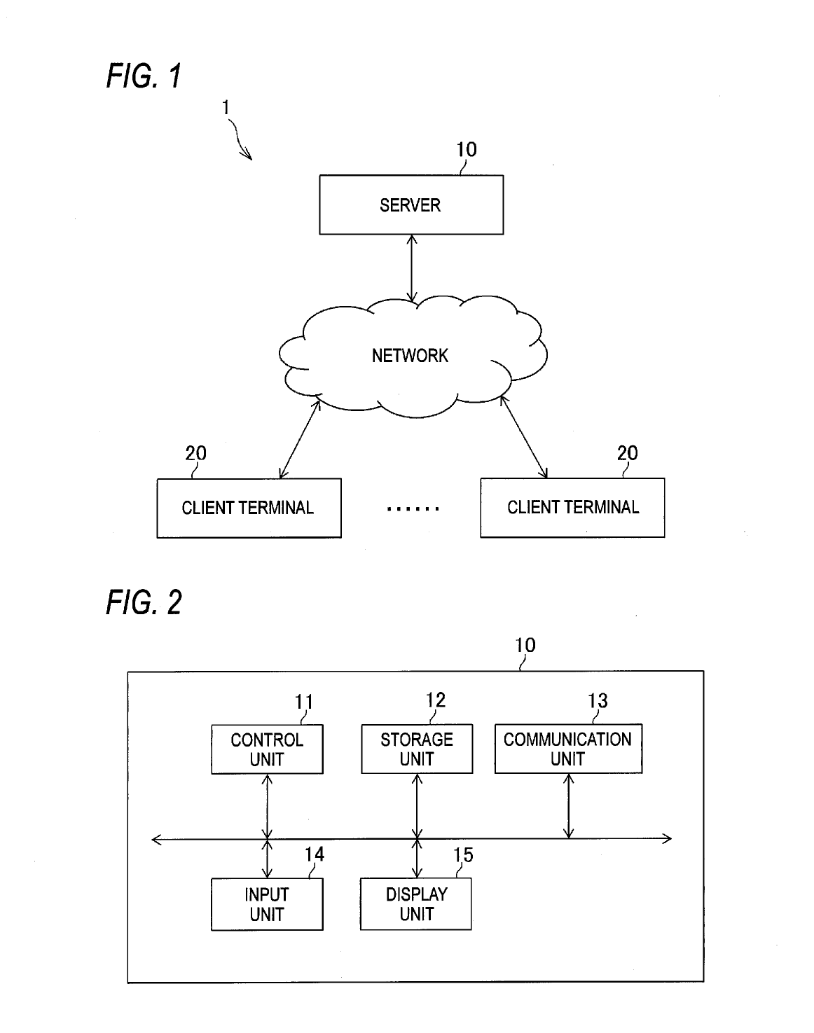

FIG. 1 is a diagram illustrating an example of an entire configuration of an information processing system 1 according to the embodiment. As illustrated in FIG. 1, the information processing system 1 according to the embodiment includes, for example, a server 10 and client terminals 20 (20-1 to 20-n). The server 10 and the client terminals 20 are connected to each other through communication means such as the local area network (LAN) or the Internet.

In the embodiment, the server 10 measures information of a bandwidth of a communication path used in data communication between the server 10 and the client terminals 20, and sets the bandwidth of the communication path used in the data communication between the server and the client terminals 20 based on information of the measured bandwidth.

[2. Description of Hardware Configuration]

Hereinafter, an example of the hardware configuration provided in the server 10 is described in order to realize the process described above.

FIG. 2 is a diagram illustrating an example of the hardware configuration of the server 10 according to the embodiment. As illustrated in FIG. 2, for example, the server 10 includes a control unit 11, a storage unit 12, a communication unit 13, an input unit 14, and a display unit 15.

The control unit 11 is, for example, a CPU or the like, and performs various kinds of information processes according to programs stored in the storage unit 12. Specific examples of the processes performed by the control unit 11 according to the embodiment are described below.

The storage unit 12 includes, for example, a memory element such as a RAM or a ROM, and a hard disk. The storage unit 12 keeps programs executed by the control unit 11, or various kinds of data. Additionally, the storage unit 12 operates as a working memory of the control unit 11.

The communication unit 13 is, for example, a network interface such as a LAN card, and transmits and receives information with the client terminals 20 through the communication means such as the LAN or the wireless communication network.

The input unit 14 is, for example, a touch panel, and a keyboard, and receives an operation input from a user.

The display unit 15 is, for example, a liquid crystal display, and displays a result of the information process by the control unit 11.

[3. Description of Functions]

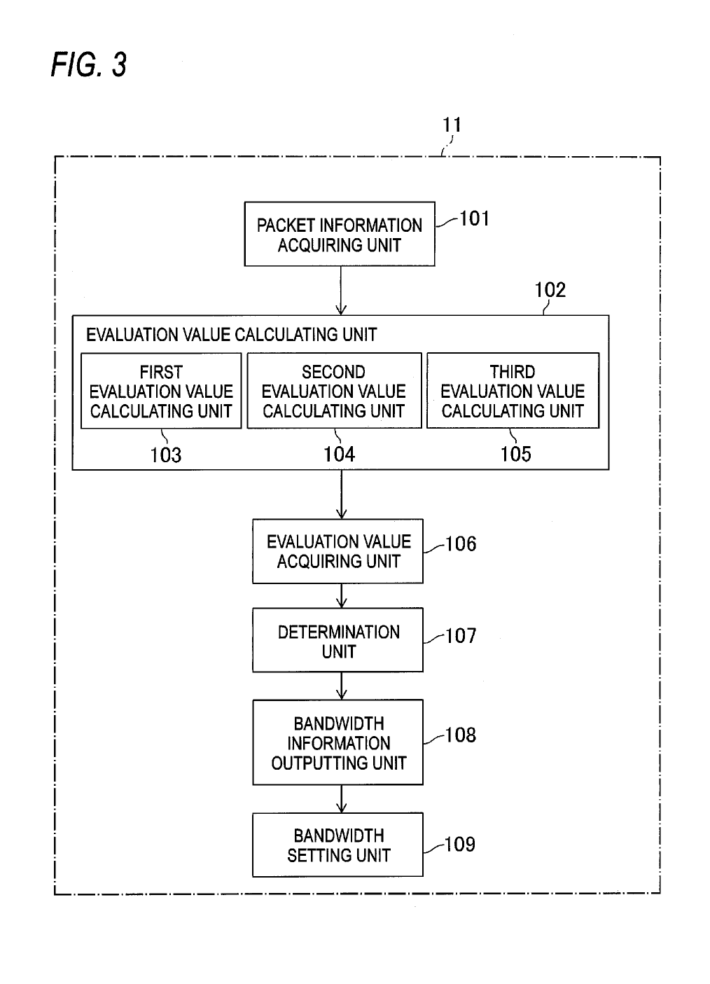

Hereinafter, functions realized by the control unit 11 of the server 10 are described. FIG. 3 is a functional block diagram illustrating an example of main functions realized by the control unit 11 of the server 10 according to the embodiment. As illustrated in FIG. 3, the control unit 11 of the server 10 is functionally configured to include, for example, a packet information acquiring unit 101, an evaluation value calculating unit 102, a first evaluation value calculating unit 103, a second evaluation value calculating unit 104, a third evaluation value calculating unit 105, an evaluation value acquiring unit 106, a determination unit 107, a bandwidth information outputting unit 108, and a bandwidth setting unit 109. These functions are realized by executing the programs stored in the storage unit 12 by the control unit 11. The programs are supplied to the server 10 through an information storage medium such as an optical disk, a magnetic disk, a magnetic tape, a magneto-optical disk, and a flash memory, or through communication means such as the Internet.

The packet information acquiring unit 101 acquires packet information received by the communication unit 13. For example, with respect to the packet information acquiring unit 101, for example, a packet of the communication unit 13 includes information of the transmission sources (identification information, a transmission bit rate, and the like of the client terminal 20), and the packet information acquiring unit 101 also acquires the information of the transmission source from the received packet. For example, the packet information acquiring unit 101 acquires reception time intervals of successively received packets (referred to as a packet pair) among plural packets received by the communication unit 13, and information on the transmission sources included in respective packets (the identification information, transmission bit rates, and the like of the client terminals 20, which are the transmission sources).

The evaluation value calculating unit 102 compares the reception time interval of the packet pair acquired by the packet information acquiring unit 101 and the transmission time interval of the packet pair calculated by the transmission bit rate, and calculates the value that evaluates a ratio of delay of the reception time interval to the transmission time interval. In the embodiment, the evaluation value is calculated by three kinds of methods; the first evaluation value calculating unit 103, the second evaluation value calculating unit 104, and the third evaluation value calculating unit 105.

The evaluation value acquiring unit 106 acquires the evaluation value calculated by the evaluation value calculating unit 102.

The determination unit 107 determines the reliability of the evaluation value acquired by the evaluation value acquiring unit 106. Here, as to the reliability of the evaluation value, first the reliability of the evaluation value to a bit rate change is determined in as general assumption. Based on the fact that the ratio of delay of the reception time interval to the transmission time interval increases as the bit rate increases, if the evaluation value is constant or increases according to the increase of the bit rate, it can be determined that the reliability of the evaluation value to the bit rate change is high. Additionally, in the embodiment, if the difference of respective evaluation values calculated by three kinds of methods is small, it is determined that the reliability of the evaluation values is high.

The bandwidth information outputting unit 108 outputs information for setting the bandwidth based on the evaluation value determined by the determination unit 107.

The bandwidth setting unit 109 sets an optimum bandwidth based on the information on the bandwidth corresponding to the bit rate output by the bandwidth information outputting unit 108.

[4. Description of Flow Charts]

Next, details of the processes realized by the server 10 are described with reference to flow charts.

[4-1. First Evaluation Value Calculating Process]

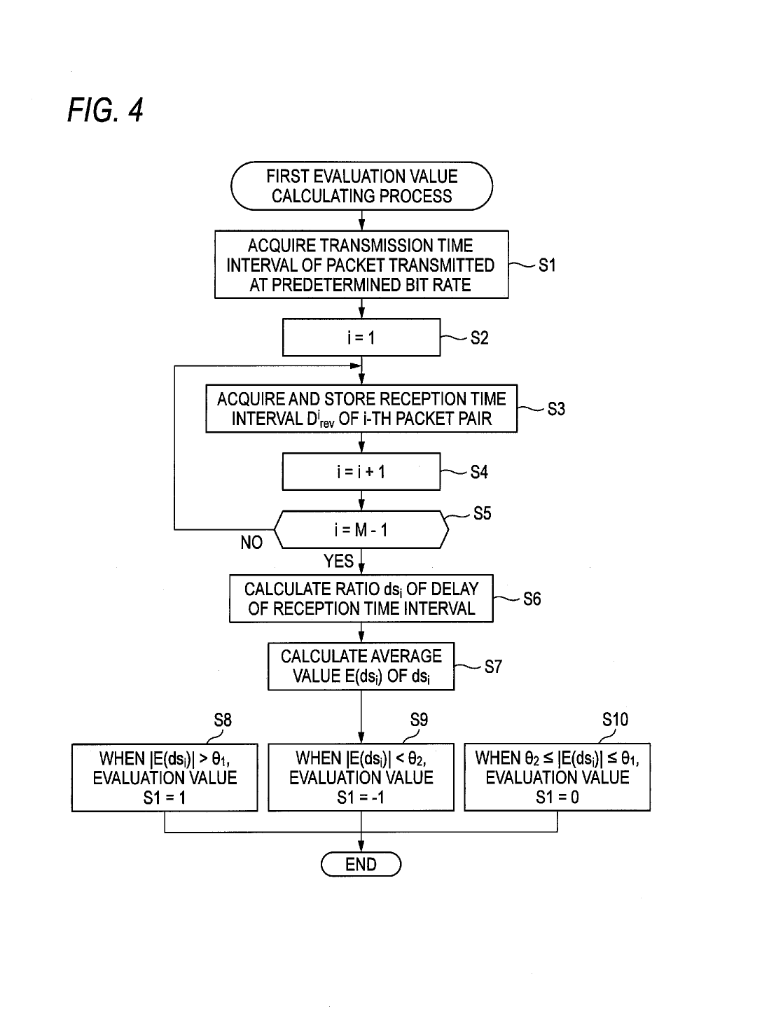

FIG. 4 is a flow chart illustrating an example of a process of calculating a first evaluation value for evaluating communication delay in a communication paths between the server 10 and the client terminal 20 (a first evaluation value calculating process).

First, the packet information acquiring unit 101 acquires the transmission time interval of the UDP packet transmitted by the client terminal 20 at a certain bit rate (S1). Then, the packet information acquiring unit 101 initializes a variable i to be 1 (S2), acquires a reception time interval Dⁱᵣₑᵥ of an i-th packet pair, and stores the reception time interval Dⁱᵣₑᵥ in the storage unit 12 (S3).

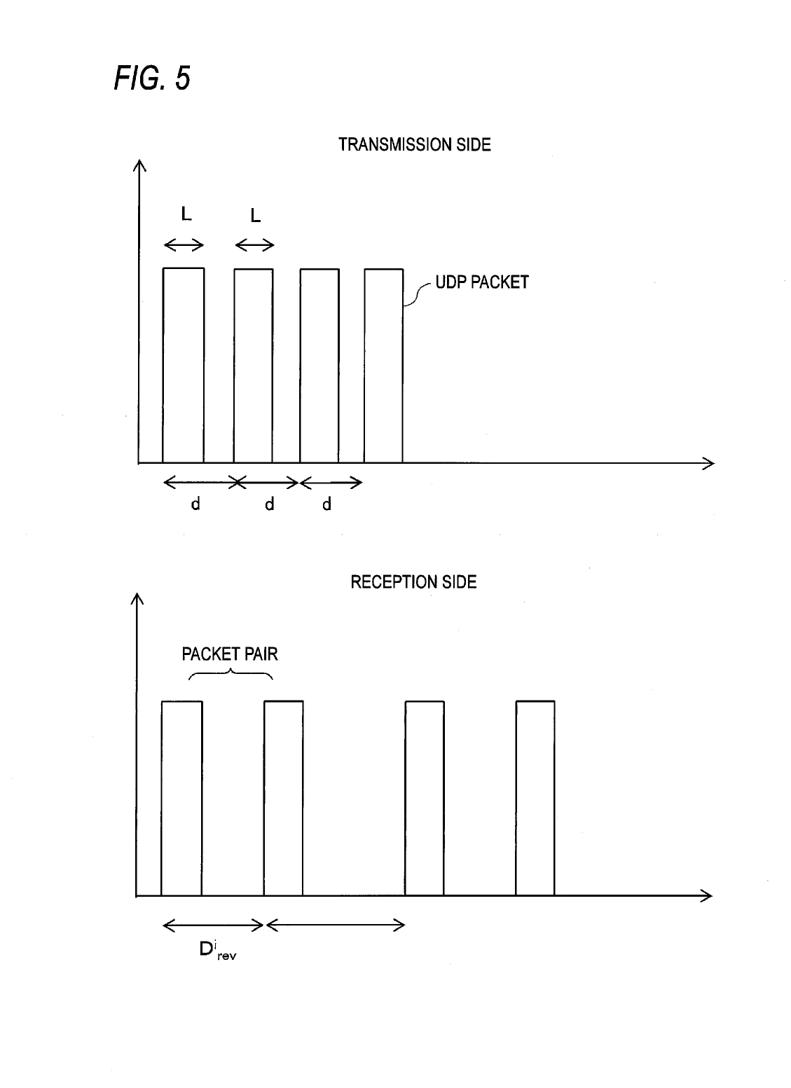

Here, the UDP packet is described. FIG. 5 is a diagram schematically illustrating an aspect of transmission and reception of the UDP packet according to the embodiment. As illustrated in FIG. 5, if a packet size of the UDP packet transmitted to the server 10 by the client terminal 20 is L (bit), and a transmission time interval of the UDP packet is d (second), the bit rate is expressed in L/d (bps). Then, a process in which the client terminal 20 transmits P items of UDP packets at the same bit rate is set to be 1 sequence.

Additionally, as illustrated in FIG. 5, 2 items of successive UDP packets received by the server 10 are set to be a packet pair, and the variable i indicates a reaching order of a packet pair reaching the server 10 among the UDP packets transmitted from the client terminal 20 in the same sequence and at the same bit rate. That is, if the client terminal 20 transmits P items of UDP packets and the server 10 receives M items of UDP packets, there are M−1 items of packet pairs. Further, the number of UDP packets received by the server 10 may be the same number of UDP packets transmitted by the client terminal 20, or may be smaller than the number of UDP packets transmitted by the client terminal 20 due to the packet loss or the like.

Then, the packet information acquiring unit 101 increments the variable i (add 1 to i) (S4), and if it is determined that the variable i is not M−1 (S5: N), the packet information acquiring unit 101 repeats the processes subsequent to Step S3.

Then, if it is determined that the variable i is M−1 (S5: Y), the packet information acquiring unit 101 uses the reception time interval Dⁱᵣₑᵥ stored in the storage unit 12 in Step S3, and calculates a ratio of delay of the reception time interval Dⁱᵣₑᵥ for each packet pair to a transmission time interval d (hereinafter, referred to as a delay ratio) dsᵢ=(Dⁱᵣₑᵥ−d)/d (S6). Then, the packet information acquiring unit 101 calculates an average value of delay ratios dsᵢ in one sequence (hereinafter, referred to as an average delay ratio) E(dsᵢ)=(Σdsᵢ)/(M−1) (S7).

Subsequently, when an absolute value |E(dsᵢ)| of the average delay ratio E(dsᵢ) calculated by the packet information acquiring unit 101 in Step S7 satisfies |E(dsᵢ)|>θ₁, the first evaluation value calculating unit 103 calculates a first evaluation value S1=1 (S8). Additionally, when |E(dsᵢ)|<θ₂, the first evaluation value calculating unit 103 calculates the first evaluation value S1=−1 (S9). Then, when θ₂≦|E(dsᵢ)≦θ₁ is satisfied, the first evaluation value calculating unit 103 calculates the first evaluation value S1=0 (S10). Here, θ₁ and θ₂ are values determined in advance and are set to, for example, 0.05 and 0.02, respectively.

In the first evaluation value calculating process, with respect to all UDP packets received by the server 10, evaluation values are calculated. Here, among the packet pairs received by the server 10, a packet pair in which the reception time interval becomes an abnormal value (which is excessively small or excessively great) exists in some cases. For example, if any of the UDP packets is lost in the middle of the communication between the client terminal 20 and the server 10, the UDP packets received before and after the lost UDP packet become a packet pair, and the reception time interval thereof becomes greater than usual. Additionally, the communication unit 13 may have an interrupt coalescing (IC) function in some cases. The IC function refers to a process in which the plurality of packets received by the communication unit 13 are cached and then interruption to the CPU is performed. Accordingly, the number of times of the interruption to the CPU decreases compared to the case where the interruption to the CPU is performed whenever the communication unit 13 receives a packet so that the CPU load is reduced. When the UDP packet received from the client terminal 20 is processed by using such IC function, the reception time interval of the packet pairs is smaller than usual. In this manner, the case where the reception time interval becomes the abnormal value is not considered in the first evaluation value calculating process. At this point, the evaluation value calculating processes (a second evaluation value calculating process and a third evaluation value calculating process) in which the abnormal value of the reception time interval is considered are described below.

[4-2. Second Evaluation Value Calculating Process]

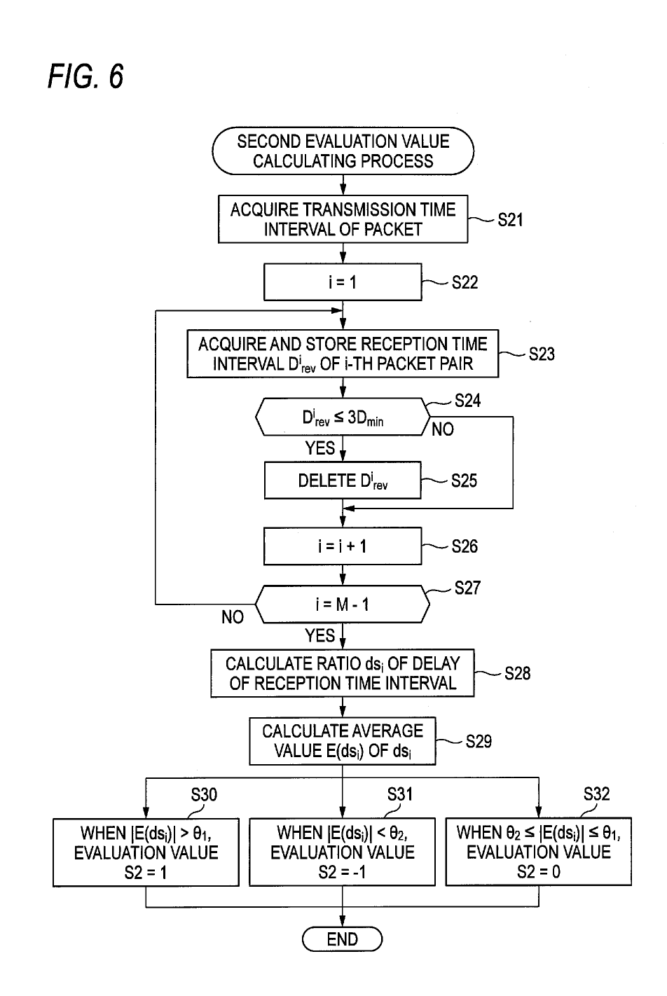

Next, a process of calculating the second evaluation value for evaluating communication delay in a communication path between the server 10 and the client terminal 20 (a second evaluation value calculating process) is described with reference to a flow chart of FIG. 6. The UDP packet transmitted by the client terminal 20 is cached and is received by the server 10 in some cases. In this case, the reception time interval Dⁱᵣₑᵥ of the packet pair is excessively small. At this point, in the second evaluation value calculating process, such an excessively small value Dⁱᵣₑᵥ is removed when calculating the evaluation value.

First, since processes from Step S21 to Step S23 in FIG. 6 are the same as the processes from Step S1 to Step S3 in FIG. 4, the repetitive descriptions are omitted.

Next, if the reception time interval Dⁱᵣₑᵥ stored in the storage unit 12 in Step S23 is equal to or smaller than 3Dₘᵢₙ (S24: Y), the packet information acquiring unit 101 deletes the reception time interval Dⁱᵣₑᵥ from the storage unit 12 (S25), and if the reception time interval Dⁱᵣₑᵥ stored in the storage unit 12 in Step S23 is greater than 3Dₘᵢₙ (S24: N), processes subsequent to Step S26 are performed. Here, Dₘᵢₙ may be a value determined in advance, or may be the minimum value among the reception time intervals Dⁱᵣₑᵥ acquired by the packet information acquiring unit 101 in the past.

Here, since processes from Step S26 to Step S29 in FIG. 6 are the same as the processes from Step S4 to Step S7 in FIG. 4, the repetitive descriptions are omitted. Then, if an absolute value |E(dsᵢ)| of the average delay ratio E(ds) calculated by the packet information acquiring unit 101 in Step S29 satisfies |E(dsᵢ)|>θ₁, the second evaluation value calculating unit 104 performs calculation so that a second evaluation value S2=1 is satisfied (S30). Additionally, when |E(dsᵢ)|<θ₂ is satisfied, the second evaluation value calculating unit 104 calculates the second evaluation value S2=−1 (S31). Then, when θ₂≦|E(dsᵢ)|≦θ₁ is satisfied, the second evaluation value calculating unit 104 calculates the second evaluation value S2=0 (S32). Here, θ₁ and θ₂ are values determined in advance, and are set to, for example, 0.05 and 0.02, respectively.

In the second evaluation value calculating process, the reception time interval Dⁱᵣₑᵥ of an excessively small value is removed from the target of the evaluation value calculating process, and a second evaluation value can be calculated. The second evaluation value calculated by this second evaluation value calculating process becomes a value with higher precision than the first evaluation value calculated by the first evaluation value calculating process.

[4-3. Third Evaluation Value Calculating Process]

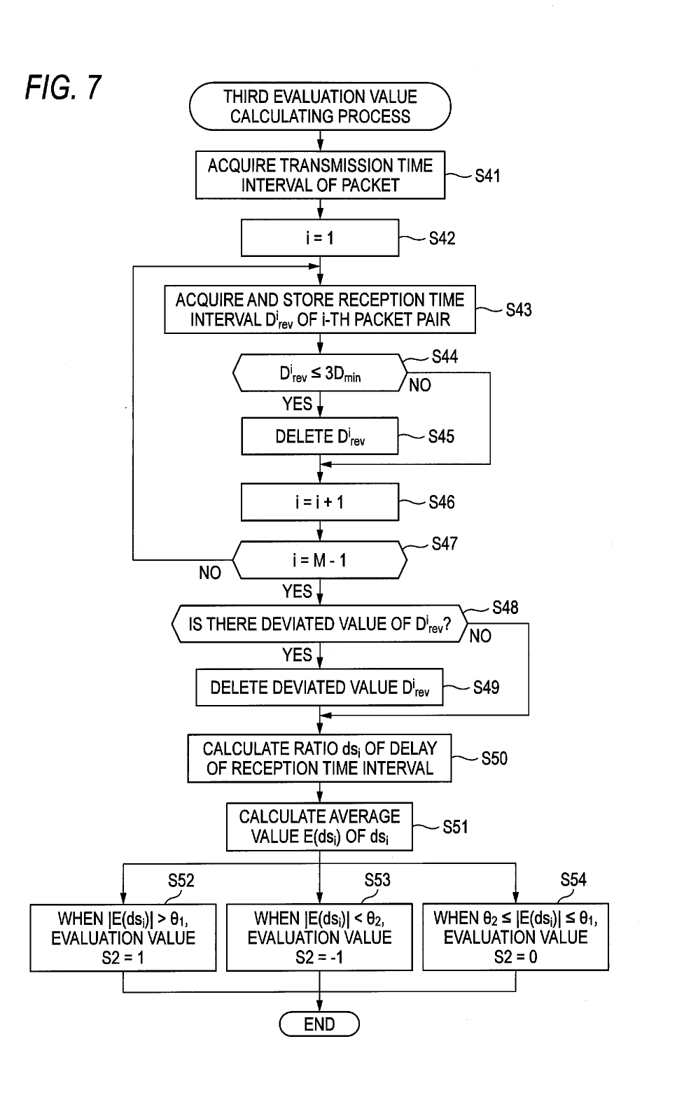

Next, a process of calculating a third evaluation value for evaluating the communication delay in the communication path between the server 10 and the client terminal 20 (a third evaluation value calculating process) is described with reference to a flow chart of FIG. 7. The server 10 may not receive the UDP packet received by the client terminal 20 or the reception time interval Dⁱᵣₑᵥ of the packet pair may be excessively great in some cases. Therefore, in the third evaluation value calculating process, the reception time interval Dⁱᵣₑᵥ of an excessively deviated value is removed from the target of the evaluation value calculating process, and an evaluation value can be calculated.

First, since processes from Step S41 to Step S47 in FIG. 7 are the same as the processes from Step S21 to Step S27 in FIG. 6, the repetitive descriptions are omitted.

Next, if there is a deviated value in the reception time intervals Dⁱᵣₑᵥ which are acquired until the variable i=M−1 is satisfied and are stored in the storage unit 12 (S48: Y), the packet information acquiring unit 101 deletes the reception time interval Dⁱᵣₑᵥ which is a deviated value from the storage unit 12 (S49). If there is not a deviated value in the reception time intervals Dⁱᵣₑᵥ which are acquired until the variable i=M−1 is satisfied and are stored in the storage unit 12 (S48: N), processes subsequent to Step S50 are performed.

Here, a well-known deviated value detecting method may be used in the detection of the reception time interval Dⁱᵣₑᵥ of the deviated value which is stored in the storage unit 12. For example, a quartile is used when the reception time intervals Dⁱᵣₑᵥ stored in the storage unit 12 are arranged in an ascending order. Then, if a first quartile is set to Q1, a second quartile is set to Q2, and a third quartile is set to Q3, values equal to or less than Q1−p(Q3−Q1) and values equal to or greater than Q3+p(Q3−Q1) are detected as deviated values. Here, p may be an arbitrary constant, and is, for example, 0.5.

Here, since processes of Step S50 and Step S51 in FIG. 7 are the same as the processes of Step S28 and Step S29 in FIG. 6, the repetitive descriptions are omitted. Then, when an absolute value |E(dsᵢ)| of the average delay ratio E(dsᵢ) calculated by the packet information acquiring unit 101 in Step S51 satisfies |E(dsᵢ)|>θ₁, the third evaluation value calculating unit 105 calculates a third evaluation value S3=1 (S52). Additionally, when |E(dsᵢ)|<θ₂ is satisfied, the third evaluation value calculating unit 105 calculates the third evaluation value S3=−1 (S53). Then, when θ₂≦|E(dsᵢ)|≦θ₁ is satisfied, the third evaluation value calculating unit 105 calculates the third evaluation value S3=0 (S54). Here, θ₁ and θ₂ are values determined in advance, and are set to, for example, 0.05 and 0.02, respectively.

In the third evaluation value calculating process, the reception time interval Dⁱᵣₑᵥ of an excessively deviated value can be removed from the target of the evaluation value calculating process. The third evaluation value calculated by this third evaluation value calculating process becomes a value with higher precision than the first evaluation value and the second evaluation value.

[4-4. First Bandwidth Setting Process]

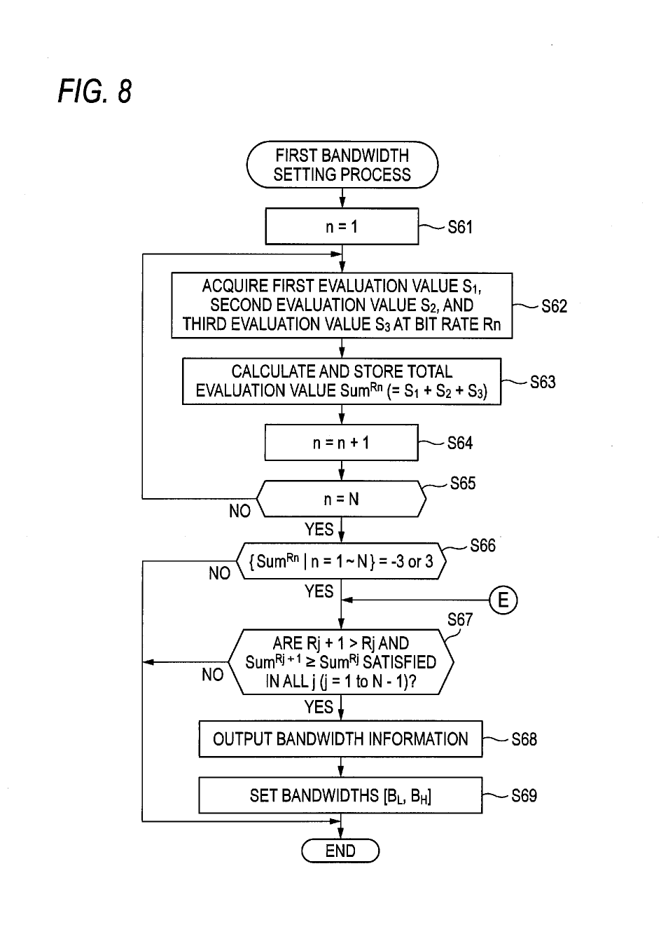

First, a first method in the bandwidth setting process (a first bandwidth setting process) is described. The first bandwidth setting process performed by the server 10 is described with reference to FIG. 8. Herein, the client terminal 20 transmits the UDP packets at N items of bit rates Rn (R1 to RN) in 1 sequence. Here, successively increasing numbers from R1 to RN are set as the bit rates Rn. Then, the bandwidth setting unit 109 sets a bandwidth based on evaluation values at the bit rate.

First, the evaluation value acquiring unit 106 initializes the variable n to be 1 (S61), and acquires the first evaluation value S1, the second evaluation value S2, and the third evaluation value S3 at the bit rate Rn (S62). Next, the evaluation value acquiring unit 106 calculates a total evaluation value Sum^{Rn}=S1+S2+S3 which is a sum of the first evaluation value, the second evaluation value, and the third evaluation value, and stores the total evaluation value Sum in the storage unit 12 (S63).

Then, a variable n is incremented (1 is added to the variable n) (S64), and if the variable n is not N (S65: N), processes subsequent to Step S62 are repeated.

Then, if the variable n is N (S65: Y), and the determination unit 107 determines that a value of the total evaluation value Sum at each of the bit rates R1 to RN is not −3 or 3 (S66: N), the first bandwidth setting process ends.

Herein, the reliability of each of the evaluation values (the first evaluation value S1, the second evaluation value S2, and the third evaluation value S3) at each of the bit rates is determined. The value of the total evaluation value Sum^{Rn} is −3 or 3, when the first evaluation value, the second evaluation value, and the third evaluation value are respectively the same values (−1 or 1). That is, since the same results are obtained in 3 kinds of evaluation value calculating processes, the corresponding evaluation value are values of great reliability. In the first bandwidth setting process, the bandwidth is set based on such evaluation values of high reliability.

Additionally, if the determination unit 107 determines that the value of the total evaluation value Sum of each of the bit rates R1 to RN is −3 or 3 (S66: Y), the determination unit 107 determines whether conditions of Rj+1>Rj and Sum^{Rj+1}≧Sum^{Rj} in all bit rate pairs j (j=1 to N−1) are satisfied (S67).

Herein, pairs of adjacent bit rates among the bit rates R1 to RN are set to be the bit rate pairs j (bit rate pair 1={R1, R2}, bit rate pair 2={R2, R3}, . . . , bit rate pair j={Rj, Rj+1}). Then, the determination unit 107 determines whether the total evaluation value Sum^{Rj+1} of the higher bit rate (Rj+1) among 2 bit rates included in each bit rate pair j of all the bit rate pairs j is equal to or greater than the total evaluation value Sum^{Rj} of the lower bit rate (Rj). That is, it is determined whether to appropriately transition the evaluation value according to the change of the bit rates. Herein, if the evaluation value increases as the bit rate increases, it is determined that the reliability of the evaluation value to the change of the bit rate is high.

Then, if the determination unit 107 determines that the conditions of Rj+1>Rj and Sum^{Rj+1}≧Sum^{Rj} are satisfied in all the bit rate pairs j (j=1 to N−1) (S65: Y), the bandwidth information outputting unit 108 outputs the total evaluation values Sum corresponding to the respective bit rates included in the sequence as bandwidth information (S68).

Then, if the bandwidth setting unit 109 sets bandwidths based on the bandwidth information output by the bandwidth information outputting unit 108 (S69). Specifically, the highest bit rate among bit rates at which the values of the total evaluation values Sum are −3 is set to be a lower limit B_{L} of the bandwidth, and the lowest bit rate among bit rates at which the values of the total evaluation values Sum^{Rn} are 3 is set to be an upper limit B_{H} of the bandwidth.

Additionally, if the determination unit 107 determines that the conditions of Rj+1>Rj and Sum^{Rj+1}≧Sum^{Rj} are not satisfied in at least one of the bit rate pairs j (j=1 to N−1) (S65: N), the first bandwidth setting process ends.

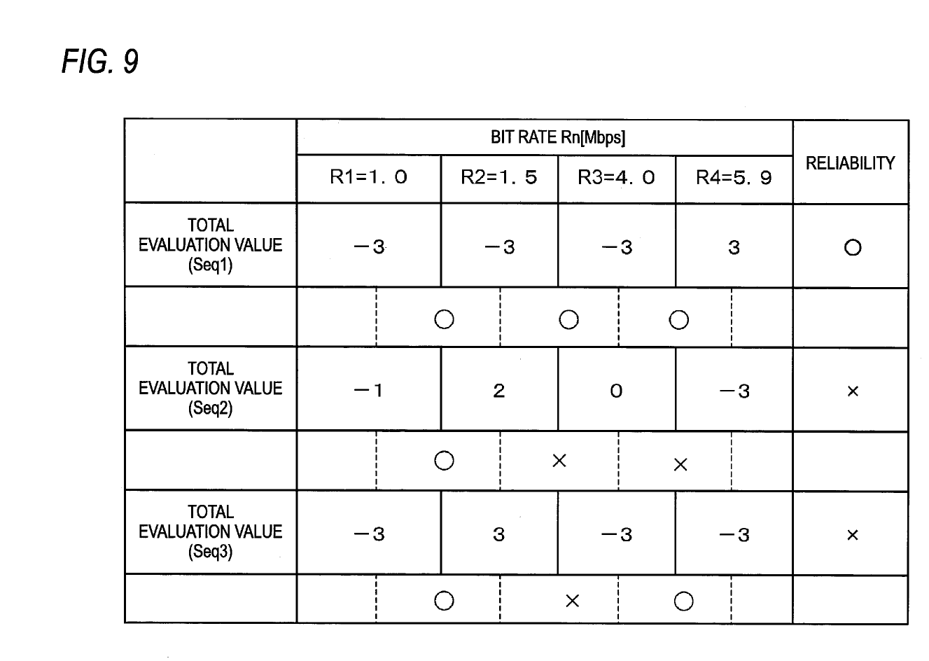

Specific examples of the first bandwidth setting processes are described with reference to FIG. 9. FIG. 9 is a diagram illustrating an example of a relationship between the bit rate Rn and the total evaluation value Sum^{Rn}. Herein, an example in which the client terminal 20 transmits the UDP packets at four bit rates of the bit rates R1 to R4 (R1=1.0 Mbps, R2=1.5 Mbps, R3=4.0 Mbps, and R4=5.9 Mbps) in one sequence is used. As illustrated in FIG. 9, values of which the total evaluation values Sum are −3 or 3 at all the bit rates R1 to R4 in Sequence 1 (Seq1) are expressed. Moreover, the conditions of Rj+1>Rj and Sum^{Rj+1}≧Sum^{Rj} are satisfied at all the bit rate pairs j (j=1 to 3) in Sequence 1, and the reliability of the evaluation values to bit rate change is satisfied. Therefore, the determination unit 107 determines that the respective evaluation values in Sequence 1 are values of high reliability. Since the total evaluation values at the bit rates R1, R2, and R3 in Sequence 2 (Seq2) are respectively −1, 2, and 0, the determination unit 107 determines that the respective evaluation values in Sequence 2 are values of low reliability. Though the total evaluation values Sum at all the bit rates R1 to R4 in Sequence 3 (Seq3) are −3 or 3, conditions of Rj+1>Rj and Sum^{Rj+1}≧Sum^{Rj} at the bit rate pair j=2 are not satisfied. Therefore, the determination unit 107 determines that respective evaluation values in Sequence 3 are values of low reliability. In FIG. 9, among portions between adjacent bit rates, O is indicated between bit rates which satisfy the reliability of the evaluation values to the bit rate change, and X is indicated between bit rates which do not satisfy the reliability of the evaluation values to the bit rate change. Then, O is indicated in the reliability of the sequence for which it is determined that the reliability of the respective evaluation values is high, and X is indicated in the reliability of the sequence for which it is determined that the reliability of the respective evaluation values is low.

Then, the bandwidth information outputting unit 108 outputs the total evaluation values corresponding to the respective bit rates included in Sequence 1 as bandwidth information.

Then, the bandwidth setting unit 109 sets the highest bit rate R3=4.0 Mbps, among the bit rates (R1, R2, R3) of which the total evaluation values are −3, to be the lower limit B_{L} of the bandwidths, and sets the lowest bit rate R4=5.9 Mbps, among the bit rates of which the total evaluation values are 3, to be the upper limit B_{H} of the bandwidths.

[4-5. Second Bandwidth Setting Process]

Next, a second method of the bandwidth setting process (second bandwidth setting process) is described. In the first bandwidth setting process, the bandwidth is set when the total evaluation values at the respective bit rates are values of high reliability which are −3 or 3. However, in the second bandwidth setting process, an optimum bandwidth can be set when the total evaluation values at the respective bit rates are not −3 or 3.

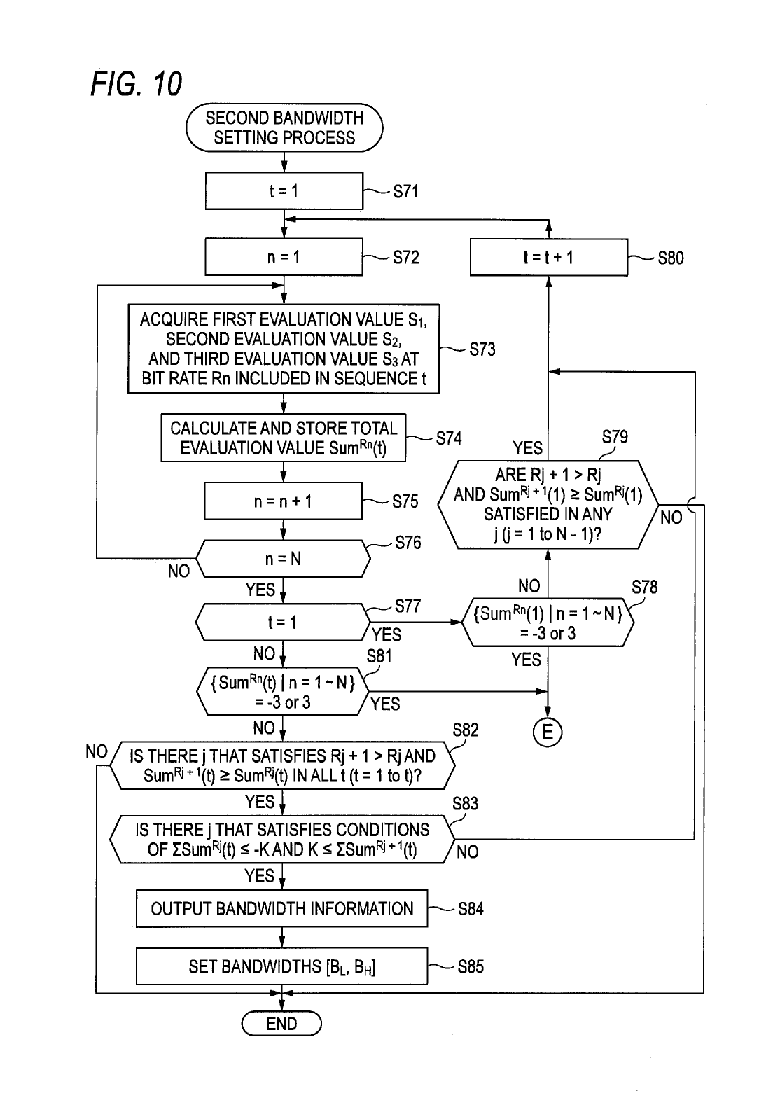

The second bandwidth setting process performed by the server 10 is described by using a flow chart in FIG. 10. Herein, the client terminal 20 transmits the UDP packets at N items of bit rates Rn (R1 to RN) in one sequence. Then, the bandwidth setting unit 109 sets the bandwidth based on the evaluation values at the bit rate.

First, a variable t is initialized to be 1 (S71), and the variable n is initialized to 1 (S72). Then, the evaluation value acquiring unit 106 acquires a first evaluation value S1^{Rn}(t), a second evaluation value S2^{Rn}(t), and a third evaluation value S3^{Rn}(t) at the bit rates Rn included in a sequence t (S73). Then, the evaluation value acquiring unit 106 calculates a total evaluation value Sum^{Rn}(t)=S1^{Rn}(t)+S2^{Rn}(t)+S3^{Rn}(t) which is a sum of the first evaluation value S1, the second evaluation value S2, and the third evaluation value S3 acquired in Step S73, and stores the total evaluation value Sum^{Rn}(t) in the storage unit 12 (S74).

Next, the variable n is incremented (1 is added to the variable n) (S75), and if the variable n is not N (S76: N), processes subsequent to Step S73 are repeated.

Then, if the variable n is N (S76: Y), and the variable t is 1 (S77: Y), the determination unit 107 determines whether the values of the total evaluation values Sum^{Rn}(1) at the bit rates Rn (n=1 to N) are −3 or 3 (S78). Herein, the reliability of the respective evaluation values (the first evaluation value S1, the second evaluation value S2, and the third evaluation value S3) at the respective bit rates is determined.

As a result of the determination in Step S77, if the values of the total evaluation values Sum^{Rn}(1) at the bit rates Rn (n=1 to N) are not −3 or 3 (S78: N), the determination unit 107 determines whether the conditions of Rj+1>Rj and Sum^{Rj+1}(1)≧Sum^{Rj}(1) at any of the bit rate pairs j (j=1 to N−1) are satisfied (S79).

Herein, since the values of the total evaluation values Sum^{Rn}(1) at the bit rates Rn (n=1 to N) are not −3 or 3, it is determined that the reliability of the respective evaluation values at the respective bit rates is low. Then, the bandwidth setting unit 109 determines that, for each pair of adjacent bit rates (bit rate pair 1={R1, R2}, bit rate pair 2={R2, R3}, . . . , the bit rate pair j={Rj, Rj+1}), the total evaluation value at the higher bit rate between the two bit rates included in the bit rate pair j is equal to or greater than the total evaluation value at the lower bit rate. Accordingly, it is determined whether there is a bit rate pair j at which the reliability of the respective evaluation values at the respective bit rates is low, but which satisfies at least the reliability of the evaluation values to the bit rate change in that the evaluation values are constant or increase according to the increase of the bit rate.

As a result of the determination in Step S79, if it is determined that the conditions are satisfied at any of the bit rate pairs j (S79: Y), the variable t is incremented (S80), and processes subsequent to Step S72 are repeated. Here, if there is a bit rate pair j at which the reliability of the respective evaluation values at the respective bit rates is low, but at least which satisfies at least the reliability of the evaluation values to the bit rate change, the evaluation value calculating unit 102 re-calculates the total evaluation values at the respective bit rates in a new sequence. Further, the evaluation value calculating unit 102 may re-calculate the total evaluation values in the new sequence only at the bit rates included in the bit rate pairs j which is determined that the conditions of Rj+1>Rj and Sum^{Rj+1}(1)≧Sum^{Rj}(1) are satisfied in Step S78.

As a result of the determination in Step S79, if it is determined that the conditions are not satisfied at any bit rate pair j (S79: N), the second bandwidth setting process ends. If there is no bit rate pair that satisfies the reliability of the evaluation values to the bit rate change, the bandwidth is not set, and the second bandwidth setting process ends.

Additionally, if the variable t is not 1 in Step S77 (S77: N), the determination unit 107 determines whether the values of the total evaluation values Sum^{Rn}(t) at the bit rates Rn (n=1 to N) included in the sequence t are −3 or 3 (S81).

Then, as a result of the determination in Step S80, if the values of the total evaluation values Sum^{Rn}(t) at the bit rates Rn (n=1 to N) included in the sequence t are not −3 or 3 (S80: N), the determination unit 107 determines whether there is a bit rate pair j at which the conditions of Rj+1>R and Sum^{Rj+1}(t)≧Sum^{Rj}(t) are satisfied in all sequences (1 to t) (S82). Herein, in any of the plural sequences, it is determined whether there is a bit rate pair j at which the reliability of the respective evaluation values is low but which satisfies at least the general assumption that the evaluation values are constant or increase according to the increase of the bit rate. Further, among one or more bit rate pairs j which are determined to satisfy the conditions of Rj+1>Rj and Sum^{Rj+1}(1)≧Sum^{Rj}(1) in Step S79, it may be determined whether there is a bit rate pair j at which the conditions Rj+1>Rj and Sum^{Rj+1}(t)≧Sum^{Rj}(t) are satisfied also in other sequences (2 to t).

As the result of the determination in Step S82, if there is one or more bit rate pairs j at which the conditions are satisfied (S82: Y), by using the bit rate pairs j at which the conditions are satisfied, the determination unit 107 determines whether there are one or more bit rate pairs j at which the conditions in which the values of sums ΣSum^{Rj}(t) of the total evaluation values Sum^{Rj}(t) at the bit rates Rj in the respective sequences t (t=1 to t) are equal to or smaller than −K (that satisfies K≧3, and is set to be, for example, K=3), and in which the values of sums ΣSum^{Rj+1} (t) of the total evaluation values Sum^{Rj+1}(t) at bit rates Rj+1 in the respective sequences t (1 to t) are equal to or greater than K are satisfied (S83).

As the result of the determination of Step S83, if it is determined that there are one or more bit rate pairs j at which the conditions are satisfied (S83: Y), the bandwidth information outputting unit 108 outputs the one or more bit rate pairs j at which the conditions are satisfied and the total evaluation values corresponding to the respective bit rates included in the corresponding bit rate pairs j, as the bandwidth information (S84).

Then, a bandwidth setting processing unit 109 sets a bandwidth based on the bandwidth information output by the bandwidth information outputting unit 108 in Step S84 (S85), and the second bandwidth setting process ends. Specifically, among one or more bit rate pairs j output by the bandwidth information outputting unit 108, the bandwidth setting processing unit 109 selects the bit rate pair j at which the sum of the absolute value of ΣSum^{Rj}(t) and the absolute value of ΣSum^{Rj+1}(t) becomes the maximum. Here, if there are a plurality of bit rate pairs j output by the bandwidth information outputting unit 108, a bit rate pair at which the reliability of the evaluation value at the respective bit rates included in the bit rate pair is higher is selected. Then, the bandwidth setting processing unit 109 sets the bit rates Rj+1 included in the selected bit rate pair j to be the upper limit B_{H} of the bandwidth, and sets the bit rate Rj to be the lower limit B_{L} of the bandwidth.

Additionally, as the result of the determination in Step S78, the values of the total evaluation values Sum^{Rn}(1) at n=1 to N are −3 or 3 (S78: Y), or as the result of the determination in Step S81, the values of the total evaluation values Sum^{Rn}(t) at n=1 to N are −3 or 3 (S80: Y), and processes subsequent to Step S67 in the first bandwidth setting process illustrated in FIG. 8 are performed.

Additionally, as the result of the determination in Step S82, if there is no bit rate pair j at which the conditions are satisfied (S82: N), the bandwidth setting unit 109 ends the second bandwidth setting process.

Additionally, as the result of the determination in Step S83, if it is determined that there is no bit rate pair j at which the conditions are satisfied (S83: N), processes subsequent to Step S80 are repeated.

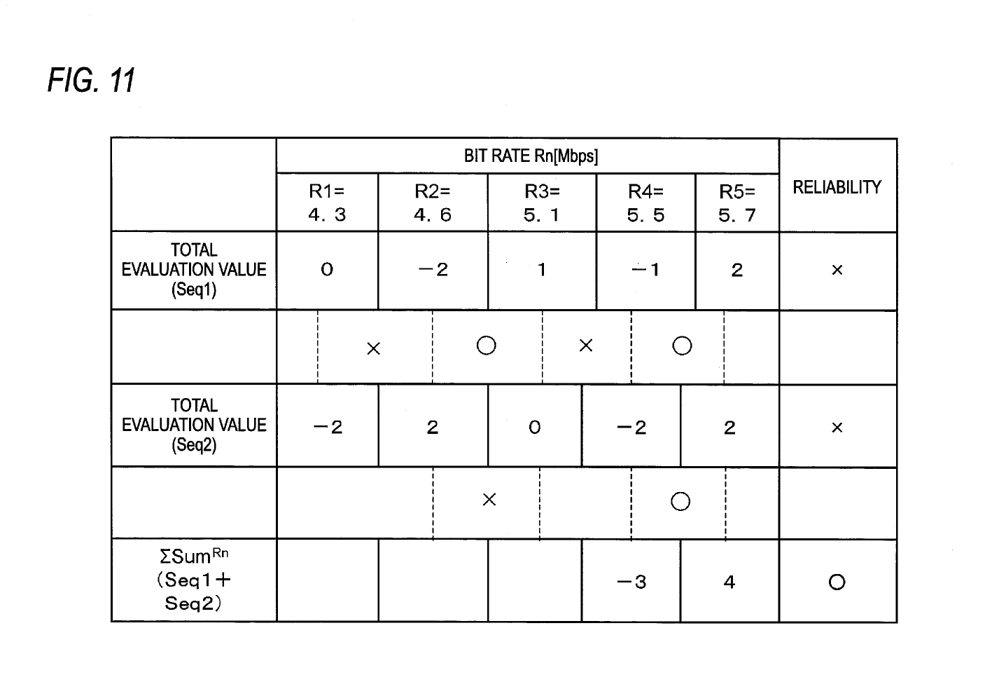

Here, specific examples in the second bandwidth setting process are described with reference to FIG. 11. FIG. 11 is a diagram illustrating an example of the total evaluation values at respective bit rates in the second bandwidth setting process. Herein, as illustrated in FIG. 11, a case in which the client terminal 20 transmits the UDP packets at 5 items of bit rates Rn (R1=4.3 Mbps, R2=4.6 Mbps, R3=5.1 Mbps, R4=5.5 Mbps, and R5=5.7 Mbps) in one sequence is used. In FIG. 11, among portions between adjacent bit rates, O is indicated between bit rates which satisfy the reliability of the evaluation values to the bit rate change, and X is indicated between bit rates which do not satisfy the reliability of the evaluation values to the bit rate change. Then, O is indicated in the reliability of the sequence for which it is determined that the reliability of the respective evaluation values is high, and X is indicated in the reliability of the sequence for which it is determined that the reliability of the respective evaluation values is low.

First, the total evaluation values at the respective bit rates in in Sequence 1 (Seq1) are calculated to be Sum^{R1}(1)=0, Sum^{R2}(1)=−2, Sum^{R3}(1)=1, Sum^{R4}(1)=−1, and Sum^{R5}(1)=2. Here, since the total evaluation values at the respective bit rates in Sequence 1 are not −3 or 3, the reliability of the respective evaluation values is low.

Therefore, the bandwidth setting unit 109 determines whether the total evaluation value at the higher bit rate among two bit rates included in the bit rate pair for each bit rate pair which is a pair of adjacent bit rates is equal to or greater than the total evaluation value of the low bit rate. Herein, in the bit rate pair 2 {R2, R3} and the bit rate pair 4 {R4, R5}, the total evaluation values of the higher bit rates among the bit rates included in the respective bit rate pairs are equal to or greater than the total evaluation values of the low bit rates. Therefore, it is determined that the bit rate pairs 2 and 4 satisfy the reliability of the evaluation values to the bit rate change in which the evaluation value increases as the bit rate increases.

Next, in Sequence 2 (Seq2), the client terminal 20 re-transmits the UDP packet at five items of bit rates Rn (R1 to R5) in the same manner as in Sequence 1. In the case of Sequence 2, the total evaluation values of the respective bit rates are calculated to be Sum^{R1}(1)=−2, Sum^{R2}(1)=2, Sum^{R3}(1)=0, Sum^{R4}(1)=−2, and Sum^{R5}(1)=2. Here, also in Sequence 2, since the total evaluation values at the respective bit rates are not −3 or 3, the reliability of the respective evaluation values is low.

At this point, in Sequence 1, with respect to the bit rate pairs 2 and 4 which are determined to satisfy the reliability of the evaluation values to the bit rate change in which the evaluation value increases as the bit rate increases, the determination unit 107 determines whether the reliability of the evaluation values to the bit rate change is satisfied in Sequence 2 in the same manner as in Sequence 1. Herein, in the bit rate pair 4, the total evaluation value at the higher bit rate among two bit rates included in the bit rate pair 4 is equal to or greater than the total evaluation value at the lower bit rate. Therefore, it is determined that the bit rate pair 4 satisfies the reliability of the evaluation values to the bit rate change. Then, with respect to the bit rate pair 4, if the total evaluation values in Sequence 1 and the total evaluation values in Sequence 2 are summed up for the respective bit rates, ΣSum^{R4}(t)=−3 in the bit rate R4, and ΣSum^{R5}(t)=4 in the bit rate R5 are calculated. In this manner, since ΣSum^{R4}(t) is equal to or less than −3, and ΣSum^{R5}(t) is equal to or greater than 3, these are determined to be values of high reliability.

Then, the bandwidth setting unit 109 sets the bandwidth based on the bit rate pair 4. That is, the bandwidth setting unit 109 sets the upper limit B_{H} of the bandwidth=R5=5.7 Mbps, and the lower limit B_{L} of the bandwidth=R4=5.5 Mbps.

Further, the invention is not limited to the embodiment described above.

For example, the bandwidth setting unit 109 is set to be included in the server 10, but may be included in the client terminal 20. In this case, the server 10 transmits the bandwidth information output by the bandwidth information outputting unit 108 to the client terminal 20.

Additionally, in the embodiment, the reliability of the evaluation values are determined, and the bandwidth is set based on the evaluation values calculated by three kinds of methods of the first evaluation value calculating process, the second evaluation value calculating process, and the third evaluation value calculating process, but any two of the three methods may be used. In this case, when the total evaluation value which is the sum of the respective evaluation values calculated by two kinds of methods is −2 or 2, the determination unit 107 determines that the reliability of the respective corresponding evaluation values is high.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a reception unit that sequentially receives a plurality of UDP packets sequentially transmitted in a certain data size and at a certain time interval;
a first calculation unit that acquires a plurality of reception time intervals each between two UDP packets successively received by the reception unit, and calculates an evaluation value for evaluating a delay state of the reception time intervals with respect to the certain time interval on the basis of the plurality of the acquired reception time intervals and the certain time interval;
a second calculation unit that calculates an evaluation value for evaluating a delay state of the reception time intervals with respect to the certain time interval on the basis of reception time intervals acquired based on a condition for deleting an abnormal value among the plurality of the reception time interval each between two UDP packets successively received by the reception unit and the certain time interval;
a determination unit that combines the evaluation value calculated by the first calculation unit and the evaluation value calculated by the second calculation unit, and determines reliability of the evaluation values based on at least the two evaluation values; and
a bandwidth information outputting unit that outputs bandwidth information according to a bit rate determined by the certain data size and the certain time interval on the basis of the reliability of the evaluation values determined by the determination unit.

2. The information processing apparatus according to claim 1, further comprising:
a bandwidth setting unit that sets an upper limit and a lower limit of a bandwidth from a plurality of the different bit rates on the basis of the bandwidth information which is output by the bandwidth information outputting unit and corresponds to each of the plurality of the different bit rates.

3. The information processing apparatus according to claim 2,
wherein the determination unit determines with respect to bit rate change, the reliability of the evaluation values which is calculated at each of the plurality of the different bit rates,
in response to the determination unit determining that the reliability of the evaluation values at the respective bit rates is low and determining that the reliability of the evaluation values to the bit rate change is high, the reception unit receives the plurality of UDP packets transmitted at the respective bit rates again, and
in response to the determination unit determining that the reliability of the evaluation values calculated at the respective bit rates which are received again is low and determining that the reliability of the evaluation values to the bit rate change is high, the bandwidth setting unit sets the upper limit and the lower limit of the bandwidth from the respective bit rates.

4. The information processing apparatus according to claim 3,
wherein in response to the evaluation values calculated at the respective bit rates which are received again and the evaluation values calculated at the respective bit rates previously received satisfying a certain standard value, the bandwidth setting unit sets the upper limit and the lower limit of the bandwidth from the respective bit rates.

5. A non-transitory computer readable medium storing a program causing a computer to execute a process for information processing, the process comprising:
sequentially receiving a plurality of UDP packets sequentially transmitted in a certain data size and at a certain time interval;
acquiring a plurality of reception time intervals each between received two UDP packets successively, and calculating an evaluation value for evaluating a delay state of the reception time intervals with respect to the certain time interval on the basis of the plurality of the acquired reception time intervals and the certain time interval;
calculating an evaluation value for evaluating a delay state of the reception time intervals with respect to the certain time interval on the basis of reception time intervals acquired based on a condition for deleting an abnormal value among the plurality of the reception time interval each between received two UDP packets successively received and the certain time interval;
combining the evaluation value being firstly calculated and the evaluation value being secondly calculated, and determines reliability of the evaluation values based on at least the two evaluation values; and
outputting bandwidth information according to a bit rate determined by the certain data size and the certain time interval on the basis of the determined reliability of the evaluation values.
